(19) United States
(12) Patent Application Publication
(10) Pub. No.: US 2016/0319417 A1
(43) Pub. Date: Nov. 3, 2016

(54) Thermal Spray for Corrosion Protection

(71) Applicant: Ford Global Technologies, LLC, Dearborn, MI (US)

(72) Inventors: James Maurice BOILEAU, Novi, MI (US); Janice Lisa TARDIFF, Plymouth, MI (US); Matthew John ZALUZEC, Canton, MI (US)

(21) Appl. No.: 14/697,932

(22) Filed: Apr. 28, 2015

(51) Int. Cl. C23C 4/12; C23C 24/04; B32B 15/01; C23C 4/08

(52) U.S. Cl. CPC C23C 4/12; C23C 4/08; C23C 24/04; B32B 15/01; B32B 2255/205; B32B 2255/06; B32B 2605/003

(57) ABSTRACT

Methods of applying a corrosion protection layer and components protected thereby are disclosed. In one embodiment, a corrosion-resistant assembly is provided including a first metal component joined to a second metal component, a joint interface between the first and second components, and a corrosion protection layer covering at least a portion of the joint interface, the corrosion protection layer including aluminum or zinc. The corrosion protection layer (CPL) may be applied by a spraying process, such as thermal spraying. The CPL may be a non-structural coating and may be formed of commercially pure aluminum (e.g., at least 99 wt. %). The CPL may form a seal between two components at the joint interface, for example, when components are joined using a hem-lock. The CPL may also be applied to newly machined surfaces, such as cut surfaces and punch surfaces to prevent or reduce corrosion.

### TECHNICAL FIELD

The present disclosure relates to a thermal spray for corrosion protection, for example an aluminum thermal spray.

### BACKGROUND

Metal components may corrode when exposed to certain environments, such as those with high levels of moisture or salt. Steel vehicle components may rust if exposed to outdoor elements, particularly if unpainted or if the paint is removed. In order to reduce vehicle weight, some steel automotive components have been replaced by aluminum components. While aluminum does not rust like iron or steel, it may oxidize or corrode in some environments. Aluminum corrosion may result in the formation of aluminum oxide, which may have a white-ish, powdery appearance. If an aluminum component, such as a vehicle component, is painted, corrosion of the underlying aluminum may cause the paint to chip, crack, bubble, or blister.

### SUMMARY

In at least one embodiment, a corrosion-resistant assembly is provided including a first metal component joined to a second metal component, a joint interface between the first and second components, and a corrosion protection layer covering at least a portion of the joint interface, the corrosion protection layer including aluminum or zinc.

In one embodiment, the first metal component may include a flange and the flange may be bent around an edge of the second metal component to form a joint between the first and second components. The joint may include the joint interface formed between a terminal end of the first metal component and the second metal component. In another embodiment, the corrosion protection layer may form a seal between the first and second metal components along a portion of the joint interface. The corrosion protection layer may have a mean thickness of 0.1 to 2.0 mm and may comprise at least 99.0 wt. % aluminum.

In one embodiment, the first and second components may be sheet metal. The first metal component may be a 6XXX series aluminum alloy and the second metal component may be a 5XXX or 7XXX series aluminum alloy. The first and second components may each be formed of an aluminum alloy and the corrosion protection layer may be formed of at least 99.0 wt. % aluminum. In one embodiment, the first metal component is an outer vehicle body panel and the second metal component is an inner vehicle body panel and the first metal component is crimped to the second metal component to form the joint interface.

In at least one embodiment, a method of increasing corrosion resistance in an assembly is provided, including thermally spraying a corrosion protection layer onto at least a portion of a joint interface between a first metal component and a second metal component, the corrosion protection layer including aluminum or zinc.

The step of thermally spraying the corrosion protection layer may include heating a source material to a temperature at or above its melting point or may include cold spraying, in which a source material for the corrosion protection layer is not heated to a temperature at or above its melting point during the spraying process. In one embodiment, thermally spraying the corrosion protection layer onto at least a portion of the joint interface includes forming a seal between the first and second metal components along a portion of the joint interface. The step of thermally spraying the corrosion protection layer may include spraying a layer comprising at least 99 wt. % aluminum. The thermally spraying step may include spraying a corrosion protection layer having a mean thickness of 0.1 to 2.0 mm. The corrosion protection layer may be sprayed onto the joint interface without prior cleaning or removal of material from the joint interface.

In one embodiment, the thermally spraying step may include spraying a corrosion protection layer onto at least a portion of a joint interface between a first metal component and a second metal component wherein the first metal component includes a flange that is bent around an edge of the second metal component to form a joint including the joint interface between the first and second components. The method may further include, prior to the thermally spraying step, bending a flange of the first metal component around an edge of the second metal component to form a joint between the first and second components, the joint including the joint interface.

In at least one embodiment, a method of increasing corrosion resistance of a sheet metal component is provided including thermally spraying a corrosion protection layer onto a cut-surface, sanded surface, or a joint interface of an aluminum sheet metal component. The corrosion protection layer may comprise at least 90 wt. % aluminum and have a mean thickness of 0.1 to 2.0 mm.

### BRIEF DESCRIPTION OF THE DRAWINGS

FIG. 1 is a perspective view of the front of a vehicle hood including inner and outer body panels;

FIG. 2 is a top plan view of the back of the vehicle hood of FIG. 1;

FIG. 3 is a cross-section of the back of the vehicle hood of FIG. 2;

FIG. 4 is another cross-section of the back of the vehicle hood of FIG. 2;

FIG. 5 is the perspective view of the front of the vehicle hood of FIG. 1 with a corrosion protection layer applied to the hem-lock joint, according to an embodiment;

FIG. 6 is the top plan view of the back of the vehicle hood of FIG. 2 with a corrosion protection layer applied to the hem-lock joint, according to an embodiment;

FIG. 7 is the cross-section of the back of the vehicle hood of FIG. 3 with a corrosion protection layer applied to the hem-lock joint, according to an embodiment;

FIG. 8 is the cross-section of the back of the vehicle hood of FIG. 4 with a corrosion protection layer applied to the hem-lock joint, according to an embodiment;

FIG. 9 is a flowchart for a method of manufacturing a component or components including a corrosion protection layer;

FIG. 10 is a flowchart for a method of repairing a component or components, including the application of a corrosion protection layer;

FIGS. 11 and 12 are images from testing done on panels of aluminum alloy 6111 (FIG. 11) and 6022 (FIG. 12) having a corrosion protection layer of commercially pure aluminum applied thereon and subjected to corrosion testing; and

FIGS. 13 and 14 are images from testing done on panels of aluminum alloy 6111 (FIG. 13) and 6022 (FIG. 14) having a corrosion protection layer of commercially pure zinc applied thereon and subjected to corrosion testing.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

As described above, aluminum has replaced steel in some automotive or vehicle components in order to reduce weight and increase fuel efficiency. While aluminum and its alloys do not rust, they do corrode under certain circumstances. High levels of moisture or salts may cause corrosion or cause it to occur more rapidly. In addition, one aluminum component may be attached to or near other aluminum components having a different composition. For example, an outer body panel formed from a 6XXX series aluminum alloy may be attached to an inner body panel formed from a 5XXX or 7XXX series aluminum alloy. The 5XXX series alloys have magnesium as their primary alloying element, while the 6XXX series alloys have magnesium and silicon as their primary alloying elements. The 7XXX series aluminum alloys have zinc, as well as magnesium and copper, as the primary alloying elements. The 6XXX series alloys may also have increased copper content compared to the 5XXX series. When dissimilar metals are in electrical contact and in the presence of an electrolyte, galvanic corrosion may occur.

Accordingly, aluminum vehicle components may be subject to corrosion in areas where moisture or salt may come in contact and stay in contact with the components, particularly if two different alloys are also present. This may occur where crevices, depressions, openings, or other areas that may allow water or salts to collect are located. For example, body panels may be attached to each other using a hem-lock or hem joint, wherein a flange of one panel is bent around an edge of the other panel and crimped under force. This crimping process may result in small openings, undercuts, lips, or other depressions or gaps between or on the two panels. These depressions or gaps may allow water or salts to contact the aluminum panels and to remain in contact with them for an extended period. Long-term contact with water and/or salt may lead to corrosion of the body panels, which may cause a subsequent paint layer to have poor adhesion or to begin to flake, bubble, or blister.

In addition to holes, gaps, depressions, etc., other areas of an aluminum component may also be susceptible to increased corrosion potential. Surfaces that have been roughened, such as by sanding, may show increased corrosion. This may be due to a removal of the aluminum component's pacifying layer or due to an increase in surface area available for oxidation. Similarly, areas that are newly exposed to the environment may show increased corrosion. For example, exposed machining surfaces, such as cut edges or punched-hole edges, may corrode more quickly than the rest of the component. This may also be due to a removal of the aluminum component's pacifying layer and a newly created surface available for oxidation.

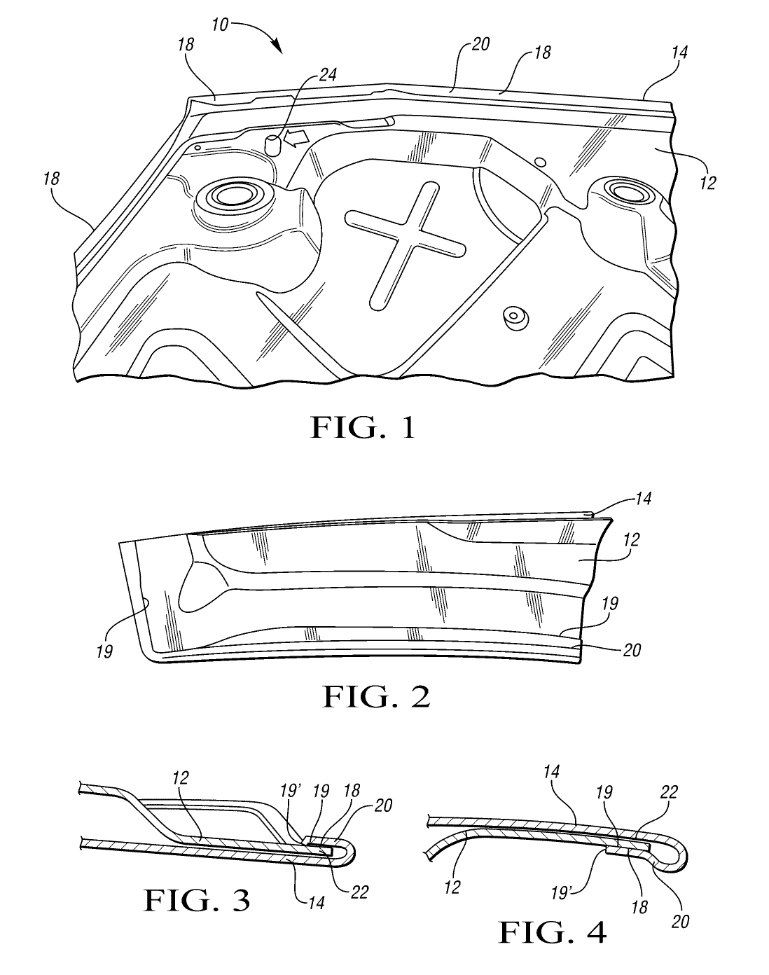

With reference to FIGS. 1-8, protective coatings and methods for applying the coatings are provided. The coatings may prevent or mitigate corrosion of aluminum components. In at least one embodiment, the components may be at an elevated risk of corrosion, for example, they may be roughened or have newly exposed surfaces or they may be joined to another component in a manner that forms holes, gaps, depressions, etc. where moisture and/or salt may collect (e.g., a hem-lock). The components may be automotive or vehicle components, however, the coatings may be applied to components in any field to prevent or reduce corrosion.

The prevention or mitigation of corrosion may include applying a corrosion protection layer to the component or components. The corrosion protection layer may cover the entire component(s) or a portion thereof. For example, the corrosion protection layer may cover a portion of the component(s) having an elevated risk of corrosion, such as roughened portions or portions having newly exposed surfaces (e.g., cut or punch surfaces) or it may be cover joints between two or more components (e.g., those that form holes, gaps, depressions, such as hem-lock joints). In at least one embodiment, the component(s) may be formed of aluminum or an aluminum alloy. The component(s) may be formed of any suitable aluminum alloy, such as the 5XXX, 6XXX, or 7XXX series aluminum alloys. The component(s) may have any shape or form-factor, such as sheet metal, cast aluminum alloys, extrusions, or hydroformed components. While the component(s) are described herein as being formed from aluminum, the component(s) may also be formed of other metals, such as iron, steel, or titanium.

As described above, the 5XXX series alloys have magnesium as their primary alloying element, while the 6XXX series alloys have magnesium and silicon as their primary alloying elements. The 7XXX series alloys have zinc as the primary alloying element. If the corrosion protection coating is applied to a joint or other mating surface of two components, the components may each be an aluminum component. The components may have the same composition or they may be different. For example, an outer body panel may be formed of a 6XXX series alloy and an inner panel may be formed of a 5XXX or 7XXX series alloy. This is merely an example, however, and either panel may be formed of a 5XXX, 6XXX, or 7XXX series alloy. The panels may be joined together by a hem-lock, which may result in holes, gaps, depressions, etc. where moisture and/or salt may collect and facilitate corrosion. While the components are described above as being formed from aluminum or an aluminum alloy, the components may formed of any metal that is susceptible to corrosion. For example, the component(s) may be formed of iron, steel, titanium, or alloys thereof.

The corrosion protection layer (CPL 16) may be formed of any material that is at least as resistant to corrosion as the component or material being covered or protected. In one embodiment, the corrosion protection layer may be formed of pure aluminum or an aluminum alloy. The term “pure aluminum” may refer to 100% pure aluminum or “commercially pure” aluminum, which may generally be considered at least 99 wt. % aluminum (e.g., at least 99.0, 99.5, or 99.9 wt. %). Examples of commercially pure aluminum alloys include the 1100 series. In another embodiment, the corrosion protection layer 16 may be formed of a low-alloy aluminum, such as a low-alloy aluminum in the DOM 2XXX, 3XXX, 4XXX, 5XXX, 6XXX, or 7XXX series. For example, the CPL 16 may be formed of an aluminum-manganese series (3xxx) alloy or an aluminum-magnesium series (5xxx) alloy. The CPL 16 may be formed of an aluminum alloy that comprises at least 90 wt. % or at least 95 wt. % aluminum. In another embodiment, the CPL 16 may match or substantially match the composition of the component being covered or protected. In addition to, or instead of, aluminum, other materials may be used for the CPL 16. For example, other metals may be used, such as zinc. Similar to the aluminum CPL 16, the zinc may be pure or a zinc alloy. The term “pure zinc” may refer to 100% pure zinc or “commercially pure” zinc, which may generally be considered at least 99 wt. % aluminum (e.g., at least 99.0, 99.5, or 99.9 wt. %). For applications where the area to be covered is small or where cost is not a concern, inert/noble metals such as ruthenium, rhodium, palladium, silver, osmium, iridium, platinum, or gold may be used. These elements may be pure (or commercially pure) or in alloy form, similar to aluminum and zinc, described above.

The corrosion protection layer may be applied to the component(s) using any suitable process. In at least one embodiment, the CPL 16 may be applied using a spraying process. The spraying process may be a thermal spraying process. In general, thermal spraying is a coating process in which a source material is sprayed onto a surface. The source material may be melted/heated or it may be “cold” such that it remains in a solid state during the entire process. In heated processes, the source material or feedstock may be heated using an electrical source (e.g. plasma or arc) or chemically (e.g., combustion).

Thermal spraying is capable of forming a relatively wide range of coating thicknesses, from microns to millimeters, and can cover a relatively large area at a high deposition rate, compared to other coating processes such as electroplating, physical and chemical vapor deposition. Materials that may be thermally sprayed may include metals, alloys, ceramics, plastics and composites. During the thermal spraying process, the source material may be heated to a liquid or softened/malleable state and accelerated towards the surface to be coated. The source material may begin as a powder or as a wire (single or multiple), and may be accelerated towards the surface as particles or droplets (e.g., micron-scale particles/droplets). In processes where the source material is melted or heated, the heat source may include combustion or electrical arc discharge. In processes where the source material is not heated or not heated to or near its melting point (e.g. cold spraying), particles are accelerated to very high speeds by a carrier gas. The solid particles impact the surface with sufficient kinetic energy to plastically deform and mechanically bond to the component. During the thermal spraying process, the sprayed particles accumulate and build up on the surface to form a coating. The coating may be continuous and non-porous and may have a uniform or non-uniform thickness. Thermal spraying includes several specific variations, any of which may be suitable for forming the disclosed CPL 16. For example, thermal spraying may include plasma spraying, detonation spraying, wire arc spraying, flame spraying, high velocity oxy-fuel coating spraying (HVOF), warm spraying, or cold spraying.

While metal spraying systems vary depending on the specific type being used, they generally include similar components. Thermal spray systems may include a spray torch or gun, which may include the components that melt and/or accelerate the particles of source material. The system may also include a feeder or hopper for supplying the powder or wire source material and gas and/or liquid supplies for generating the flame or plasma jet and/or carrier gases for carrying the powder. The system may include a robot for controlling and operating the torch/gun and/or for moving/holding the components to be coated. The thermal spraying process may be performed in open-air or in a closed environment, such as a chamber. The process may be performed in ambient air, in an inert gas atmosphere (e.g., argon or nitrogen, or mixtures thereof), under low pressure, or in a vacuum. The thermal spraying process may be controlled by one or more computers. In at least one embodiment, the thermal spraying process may be added to or incorporated into an assembly or manufacturing line, such as an automotive or vehicle assembly line.

With reference to FIGS. 1-8, the disclosed corrosion protection layer 16 may be applied to an automotive component 12 or components 12, 14. For example, the CPL 16 may be applied to areas of the component(s) that have been roughened, for example by sanding, or have newly exposed surfaces, for example due to cutting or punching. In addition, the CPL 16 may be applied to components that are joined together in a manner that may form holes, gaps, depressions, cavities, etc. where moisture and/or salt may collect, such as a hem-lock or other crimped joint. While the CPL 16 and the methods are shown and described with respect to automotive components, components in any field may be similarly treated.

A vehicle hood 10 is shown in FIGS. 1-4, in which an outer panel 14 is attached to an inner panel 12 by a hem-lock or joint 18. As used herein, a hem-lock is a type of joint between two components, such as panels or sheets, wherein an edge or flange of one component is bent around and crimped to an edge or flange of another component. As shown in FIGS. 1-4, a flange 20 of the outer panel 14 may be bent around and edge 22 of the inner panel 12 and crimped thereto. The flange 20 may be at a terminal end of the panel 14. While the outer panel 14 is shown crimped around an edge of the inner panel 12, the joint 18 may also be created with the opposite configuration (e.g., inner panel crimped around outer panel). The joint 18 may include a joint interface 19 between the two components 12, 14. The joint interface may include the surfaces where the two components are joined. For components 12 and 14 joined by a hem-lock, the joint interface 19 may include a portion 19′ where the end of the flange 20 meets the inner panel 12. The portion 19′ may also be described as the exposed portion 19′ of the joint 18 (e.g., exposed to the atmosphere or environment). This portion 19′ may include the gaps, depressions, holes, etc., described above and below, wherein corrosive substances can reside. An adhesive may be applied to further join the two panels. The hood may also include holes or openings therein, such as a hole 24, shown in FIG. 1, which may be an opening for a hood prop. These holes may be machined, for example, by punching, and may form a new surface 26 in the component 12.

In the automotive industry, certain vehicle parts may include inner and outer components, with the inner components providing certain functionality and the outer components providing an improved aesthetic. The inner and outer components, such as the panels shown in FIGS. 1-4, may be formed from the same or different materials. In one embodiment, the components may both be formed of an aluminum alloy, which may be the same or different. For example, the outer panel may be formed of a 6XXX series aluminum alloy, such as 6022, 6111, or 6014, and the inner panel may be formed of a 5XXX or 7XXX series aluminum alloy, or vice versa. Alternatively, both panels may be made of a 5XXX, 6XXX, or 7XXX series aluminum alloy.

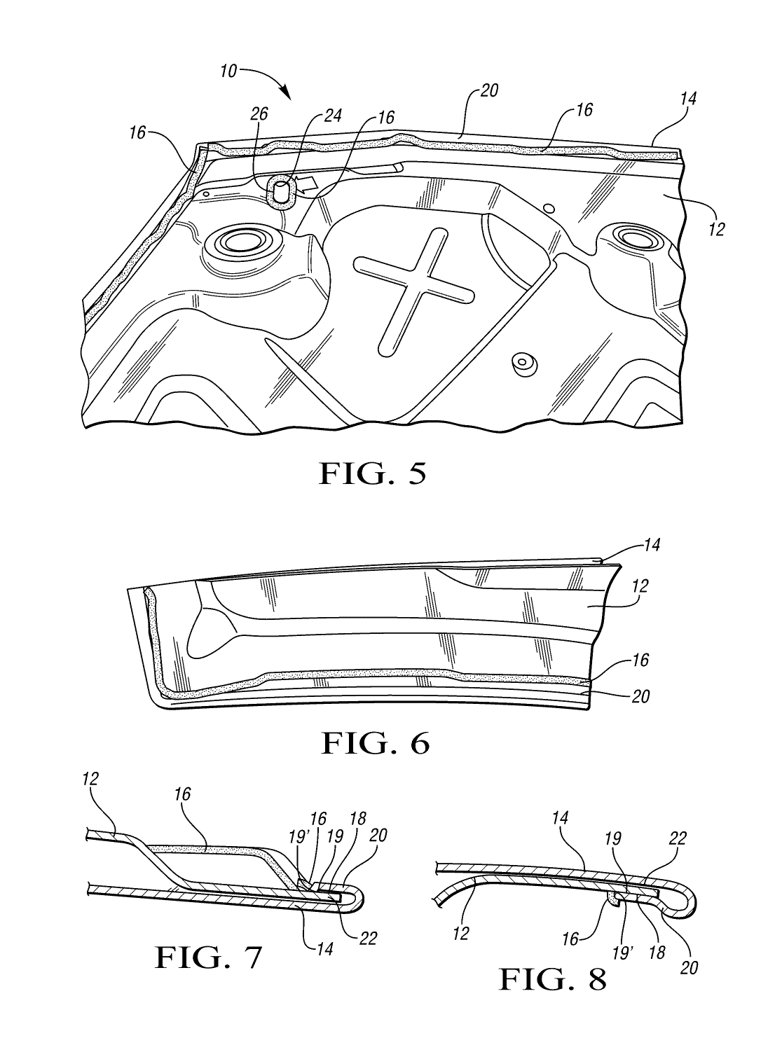

FIGS. 5-8 show the components in FIGS. 1-4 with a corrosion protection layer 16 applied thereon. The CPL 16 may cover a portion or all (or substantially all) of the hem-lock joint 18 and/or the joint interface 19 between the inner and outer body panels. In the embodiments shown in FIGS. 5-8, the CPL 16 may be in the form of a strip that extends along the joint 18 and joint interface 19, however, the CPL 16 may have any suitable shape or configuration to cover regions having increased risk of corrosion. In addition to a strip along the joint 18 and/or joint interface 19, the CPL 16 may also be applied around a portion or all of the perimeter of the opening 24 shown in FIG. 5, which may be an opening for a hood prop. As described before, surfaces that have been cut or punched may be more susceptible to corrosion, therefore, the opening 24, which may be punched, may receive the CPL 16 on and/or around the punched surface 26.

When the inner and outer panels are joined, for example using a hem-lock, a seam, mating surface, or joint interface 19 may be created between the two components. In some instances, the seam may include holes, gaps, depressions, cavities, or other regions where the two components are not in complete and/or continuous contact with each other. These regions may allow for water/moisture, salts, or other corrosive substances to collect and react with the components. As shown, the CPL 16 may cover all or a portion of the joint 18 and/or the joint interface 19 between the two components such that moisture, salt, or other corrosive substances cannot enter and/or reside within any gaps, depressions, openings, holes, etc. between the two components. The CPL 16 may cover at least a portion 19′ of the joint interface 19 where the end of the flange 20 meets the inner panel 12 (e.g., the exposed portion of the joint). This may form a seal between the inner panel 12 and the outer panel 14 along a portion 19′ of the joint interface 19. The seal may therefore prevent corrosive substances from entering any openings or gaps between the two panels.

The CPL 16 may have a uniform or non-uniform thickness. For a relatively consistent joint 18 or a uniformly roughened surface, the CPL 16 may have a uniform or substantially uniform (e.g., the thickness stays within ±10% of the mean) thickness. If the joint 18 or surface is irregular, for example with certain areas having more or larger gaps, holes, etc., then the CPL 16 may be non-uniform such that more protective material may be deposited in areas with larger gaps, holes, etc. to make the CPL 16 thicker in those areas. These are merely examples, however, and the thickness and uniformity of the CPL 16 may be adjusted as-needed based on the component(s) being covered.

The CPL 16 may have any thickness that is suitable to provide a protective barrier to the component(s) being covered. In one embodiment, the CPL 16 may have a thickness of at least 0.1 mm, for example, at least 0.3 mm or at least 0.5 mm. In another embodiment, the CPL 16 may have a thickness of 0.1 to 5.0 mm, or any sub-range therein. In one embodiment, the CPL 16 may have a thickness of 0.1 to 3.0 mm, 0.1 to 2.0 mm, 0.1 to 1.5 mm, 0.1 to 1.2 mm, 0.1 to 1.0 mm, 0.2 to 1.0 mm, 0.3 to 1.0 mm, 0.5 to 1.0, 0.2 to 0.8 mm, 0.3 to 0.8 mm, 0.3 to 0.7 mm, or about 0.5 mm (e.g., ±0.1 mm). The thickness described herein may be the absolute thicknesses or the mean/average thickness.

The CPL 16 may be a non-structural layer, in that it does not provide additional strength, stiffness, or other mechanical properties to the component being covered (or is not required to). As described above, the CPL 16 may be relatively thin (e.g., about 0.5 mm) and may be made of relatively soft material (e.g., commercially pure aluminum). Accordingly, the primary function of the CPL 16 may be to prevent or reduce corrosion of the component being covered. The CPL 16 may be applied to a component without washing, treating (e.g., chemically), grinding, cutting, or sanding the component, or otherwise preparing the component or removing material therefrom. The CPL 16 may build-up the surface being covered and may not require any smoothing or feathering with respect to the covered surface. Since the CPL 16 may be non-structural, concerns regarding stress concentrations or disrupting the shape or geometry of the covered component are reduced or eliminated.

After the CPL 16 is applied to a substrate or component, typical additional processing or manufacturing steps can be performed on the component in the same manner as components without the CPL 16. For example, if the component is an automotive component, such as a vehicle hood having inner and outer panels (e.g., as shown in FIGS. 1-4), then one or both of the panels may be painted on at least one surface during the manufacturing/assembly process. The painting process may also include a pre-treatment, such as an acidic pre-treatment, prior to painting. The CPL 16 may be painted using the same process as components not having a CPL 16, and the CPL 16 may be unaffected by the pre-treatment (e.g., not degraded or removed).

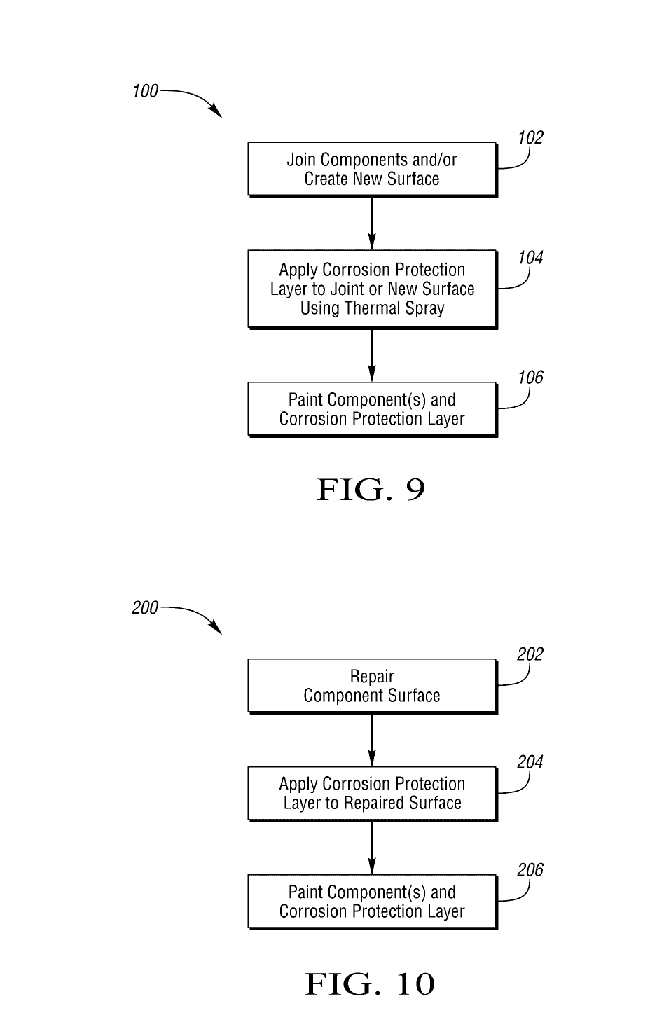

With reference to FIG. 9, a flowchart 100 is disclosed for a method of forming a corrosion-resistant component using a corrosion protection layer. In step 102, two or more components are joined to each other or a new surface is created on one or more components. Joining of the components may include any joining method, such as a hem-lock, rivet, weld, fastener (e.g., screw or bolt), or others. Creating a new surface may include roughening, sanding, grinding, cutting, punching, or other machining processes that remove material and expose a new surface 26 to the atmosphere/environment. As described above, joining two or more components together may create gaps, holes, depressions, openings, etc. that allow corrosive substances such as water and salt to contact the components for extended periods of time. Similarly, creating a new surface 26 in the component may remove a previously existing pacifying surface layer, thereby exposing the component to the atmosphere/environment.

In step 104, a corrosion protection layer (CPL 16) is applied to the joint/joint interface or new surface created in step 102. The CPL 16 may be applied by a spraying process, such as thermal spraying. In one embodiment, the CPL 16 is applied by thermal spraying, which may be hot or cold spraying. The CPL 16 may include, consist of, or consist essentially of aluminum (e.g., pure or commercially pure) or an aluminum alloy. The CPL 16 may also include, consist of, or consist essentially of zinc or inert/noble metals such as ruthenium, rhodium, palladium, silver, osmium, iridium, platinum, or gold. Alloys of the above metals may also be used. The CPL 16 may be applied to the component(s) only in areas including or near/surrounding a joint 18 or newly created surface 26 (e.g., by roughening or cutting/punching). For example, the CPL 16 may be applied to at least a portion of a joint interface 19 between two components to form a seal between the two components at the joint interface. The CPL 16 may be applied without pre-treating the coated area (e.g., chemical treatment or material removal). In one embodiment, the CPL 16 may be a non-structural coating that does not significantly affect the mechanical properties of the component(s). The CPL 16 may be an additive layer in that it does not repair or replace material removed from the component(s). The CPL 16 may cover or coat all of the joint 18 area, joint interface 19 area (e.g., the exposed portion of the joint), new surface 26, or only a portion thereof. The CPL 16 may take any shape necessary to cover the joint 18 area/new surface 26, such as a strip along an exposed portion of a joint 18 between components or a ring around a punched hole. The CPL 16 may be applied with a thickness of 0.1 to 2.0 mm and may have a substantially uniform thickness.

In step 106, the component(s) and/or the CPL 16 may be painted or otherwise coated. For example, if one of two joined components is an exterior automotive component (e.g., outer hood body panel), then the component may receive a standard automotive paint. The painting process may include pre-treatments, such as an acidic pre-treatment, which may also be applied to the applied CPL 16. For component(s) that do not typically receive a paint coat or other coating, step 106 may be optional. In addition to, or instead of, painting, other coatings may be applied, such as a sealer.

Accordingly, steps 102 to 106 may form component(s) having a corrosion protection layer applied thereon. The CPL 16 may be applied in regions where a joint between two components is formed or where a newly created surface exists, for example due to a machining process. The CPL 16 may prevent or reduce the amount of corrosion that occurs at the joint/new surface by reducing or eliminating areas or regions where corrosive substances like salt and moisture can react with the components. The CPL 16 may be non-structural and thin (e.g., 0.1-2.0 mm). The CPL 16 may therefore be a preventative measure against corrosion in newly manufactured or fabricated components.

With reference to FIG. 10, a flowchart 200 is disclosed for a method of repairing a component using a corrosion protection layer. In step 202, one or more components may be repaired, including performing processes to restore a surface of the component(s). The repair may include joining two components together to form a joint surface. Joining of the components may include any joining method, such as a hem-lock, rivet, weld, fastener (e.g., screw or bolt), or others. The repair may also include creating a new surface 26 on the component. Creating a new surface 26 may include roughening, sanding, grinding, cutting, punching, or other machining processes that remove material and expose a new surface 26 to the atmosphere/environment. For example, if the component is an automotive body panel and the vehicle is in an accident, the panel may need to be repaired. The repair may include shaping processes to restore the panel's original shape and the component may need to be sanded in order to remove smudged or transferred paint. As described above, joining two or more components together may create gaps, holes, depressions, openings, etc. that allow corrosive substances such as water and salt to contact the components for extended periods of time. Similarly, creating a new surface 26 in the component may remove a previously existing pacifying surface layer, thereby exposing the component to the atmosphere/environment.

In step 204, a corrosion protection layer (CPL 16) is applied to the repaired surface created in step 202, which may be a joint 18, joint interface 19 (or exposed portion 19′), or new surface 26. The CPL 16 may be applied by a spraying process, such as thermal spraying. In one embodiment, the CPL 16 is applied by thermal spraying, which may be hot or cold spraying. The CPL 16 may include, consist of, or consist essentially of aluminum (e.g., pure or commercially pure) or an aluminum alloy. The CPL 16 may also include, consist of, or consist essentially of zinc or inert/noble metals such as ruthenium, rhodium, palladium, silver, osmium, iridium, platinum, or gold. Alloys of the above metals may also be used. The CPL 16 may be applied to the component(s) only in areas including or near/surrounding the repaired surface. The CPL 16 may be applied without pre-treating the coated area (e.g., chemical treatment or material removal) or it may be applied after processes such as sanding, cleaning, or other processes generally performed when repairing a component surface. In one embodiment, the CPL 16 may be a non-structural coating that does not significantly affect the mechanical properties of the component(s) and does not form a mechanical/structural repair. The CPL 16 may be an additive layer in that it does not repair or replace material removed from the component(s). The CPL 16 may cover or coat all of the repair surface or only a portion of it. The CPL 16 may take any shape necessary to cover the repair surface, such as a strip along a joint 18/joint interface 19 between components, a ring around a punched hole, or a regular or irregular flat surface covering a sanded or otherwise repaired surface. The CPL 16 may be applied with a thickness of 0.1 to 2.0 mm and may have a substantially uniform thickness.

In step 206, the component(s) and/or the CPL 16 may be painted or otherwise coated. For example, if one of two joined components is an exterior automotive component (e.g., outer hood body panel), then the component may receive a standard automotive paint. The painting process may include pre-treatments, such as an acidic pre-treatment, which may also be applied to the applied CPL 16. For component(s) that do not typically receive a paint coat or other coating, step 206 may be optional. In addition to, or instead of, painting, other coatings may be applied, such as a sealer.

Accordingly, steps 202 to 206 may form repaired component(s) having a corrosion protection layer applied thereon. The CPL 16 may be applied in regions where a repair was made, such as a joint 18 between two components or where a newly created surface 26 exists, for example due to a repair machining process (e.g., sanding). The CPL 16 may prevent or reduce the amount of corrosion that occurs at the repaired surface by reducing or eliminating areas or regions where corrosive substances like salt and moisture can react with the components. Areas or regions of the original component(s) may have been smooth, continuous, or free of gaps/holes/depressions/etc., but the repair process may create areas that are rough, discontinuous, or include gaps/holes/depressions/etc. The CPL 16 may be non-structural and thin (e.g., 0.1-2.0 mm). The CPL 16 may therefore restore the corrosion protection of the component being repaired and provide a preventative measure against future corrosion in the repaired components.

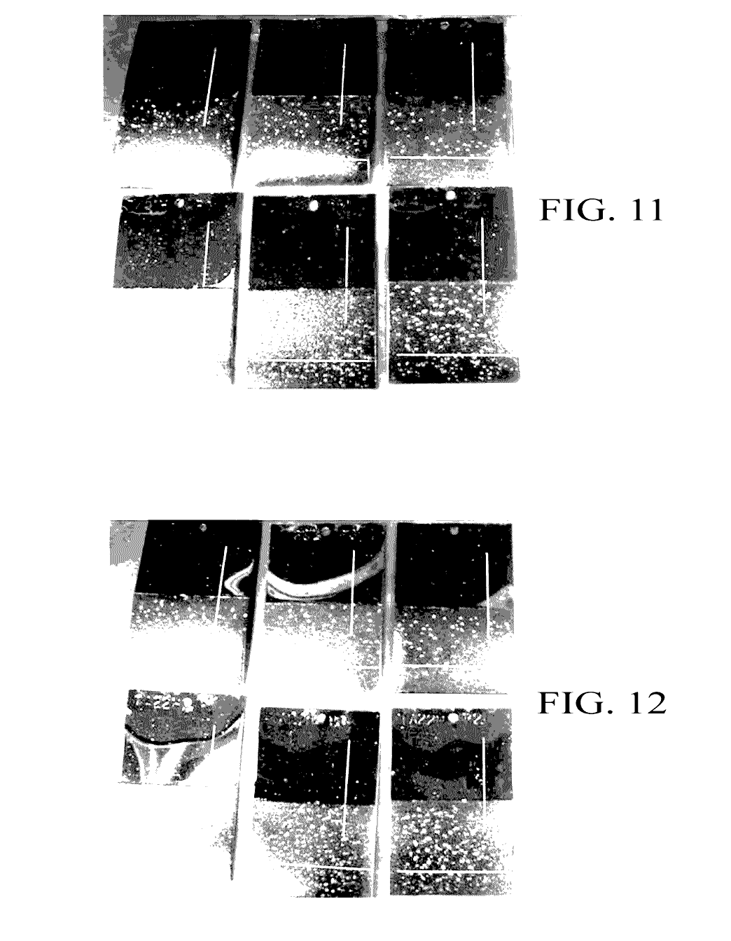

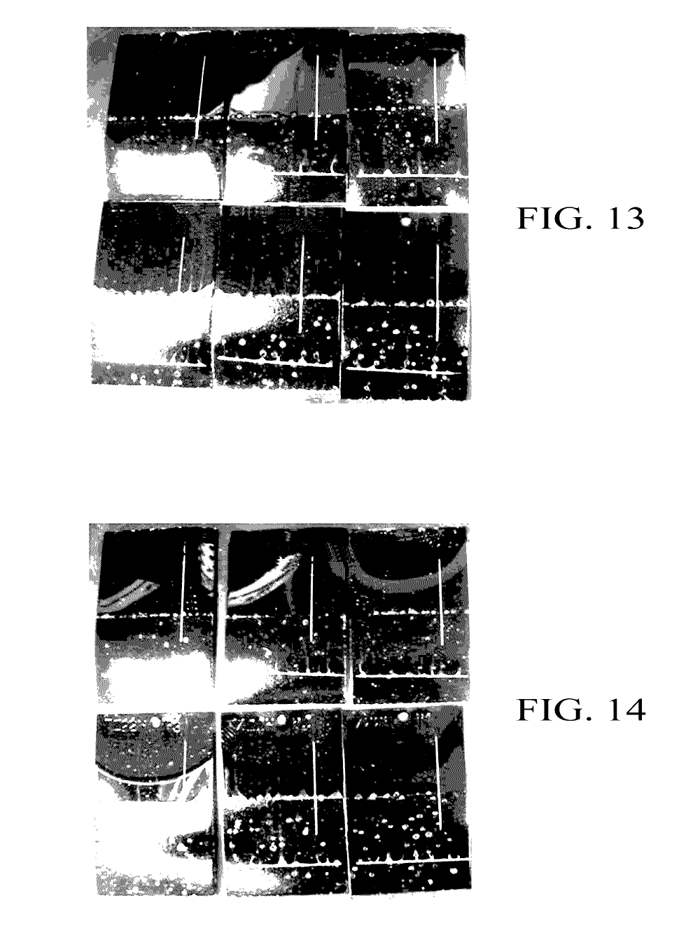

With reference to FIGS. 11-14, test samples are shown for aluminum panels coated with aluminum and zinc corrosion protection layers. The aluminum was commercially pure aluminum and the zinc was commercially pure zinc. Two aluminum alloy panel substrates were tested, 6111 and 6022. The aluminum and zinc layers were applied to the bottom half of each panel using a thermal spray process. Three panels of each substrate were coated with a 0.5 mm thick CPL 16 and three panels of each substrate were coated with a 1.0 mm thick CPL 16. The panels were entirely painted using a standard automotive zinc phosphate pretreatment, electrocoat, primer-surfacer, and topcoat. The appearance of the portion of the panels coated with the aluminum and zinc layers is rougher than the standard automotive painted surface. The painted panels were then exposed to a cyclic corrosion test for 12 weeks. As can be seen in FIGS. 11-12, the coated portions of the aluminum substrates covered with an aluminum CPL show bubbling in the paint, which is caused by an interaction between the CPL and the automotive paint system. However, the scribe line through the paint system and CPL to the underlying aluminum substrate exhibits no corrosion, indicating good corrosion protection and inhibition to the initiation of corrosion. FIGS. 13-14 show the aluminum panels covered with a zinc corrosion protection layer. The portions of the aluminum panels covered with zinc display greater levels of bubbling in the paint compared to those coated with aluminum, but the scribe line through the paint system and zinc CPL indicates good protection from corrosion. From an appearance perspective the aluminum thermal spray coating showed less bubbling than the zinc thermal spray coating, however both were effective. The zinc coating showed some bubbling of the paint at the interface between the thermal spray and the panel interface.

The thinner CPL 16 (0.5 mm) exhibited less bubbling compared to the thicker CPL 16 (1.0 mm) for both the aluminum and zinc CPL 16s. Since the CPL 16 may be non-structural, thinner CPL 16s may therefore be beneficial since less material can be used and the coating time may be reduced, while provided an improved appearance to the painted component. The test samples were also scribed across the CPL 16/aluminum interface and in the coated portion of the samples. As shown, the samples with aluminum CPL 16s showed little or no additional corrosion along the scribe lines. In the samples with zinc CPL 16s, however, the scribe lines in the coated area displayed some bleeding of the sacrificial zinc layer onto the painted surface. Combined with the bubbling at the interface, described above, the test indicates that aluminum may be a better material than zinc for the CPL 16 layer on aluminum components. However, a zinc CPL 16 may still be preferable to uncoated surfaces.

With reference to Table 1, below, corrosion data is shown for a 12-week cyclic corrosion test on 17 panels of 6111 aluminum alloy. 5 panels were uncoated, 6 panels were thermal sprayed with commercially pure zinc (3 at 1.0 mm thickness and 3 at 0.5 mm thickness), and another 6 panels were thermal sprayed with commercially pure aluminum (3 at 1.0 mm thickness and 3 at 0.5 mm thickness). Each panel was scribed and corrosion data was recorded after the corrosion test. The level or amount of corrosion was determined by measuring the total area of the corrosion extending from the scribe line. The scribes had a total area of about 1 mm², each. As shown in the table, the uncoated panel showed a significant level of corrosion, with about 4.44 mm² of corrosion area. In contrast, the zinc-coated panel showed greatly reduced levels of corrosion for both a 1.0 and a 0.5 mm thick thermal spray coating with about 0.3 and 0.4 mm², respectively. The aluminum coating was even more effective, with no corrosion occurring for either the 1.0 or 0.5 mm thick thermal spray coating. The data in Table 1 further confirms that a commercially pure aluminum spray coating is effective at reducing corrosion of an underlying aluminum alloy component. Zinc is also effective at reducing corrosion, however, it may be less effective than aluminum.

TABLE 1

| Thermal Spray Alloy | Thermal Spray Thickness | Corrosion Area |
|---|---|---|
| None | — | 4.44 +/− 2.27 mm² |
| Zinc | 0.5 mm | 0.40 +/− 0.09 mm² |
| | 1.0 mm | 0.30 +/− 0.22 mm² |
| Aluminum | 0.5 mm | 0.00 +/− 0.00 mm² |
| | 1.0 mm | 0.00 +/− 0.00 mm² |

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A corrosion-resistant assembly, comprising:
a first 6XXX series aluminum alloy component joined to a second 5XXX or 7XXX series aluminum alloy component;
a joint interface between the first and second components; and
a corrosion protection layer covering at least a portion of the joint interface, the corrosion protection layer including at least 99.0 wt. % aluminum.

2. The assembly of claim 1, wherein the first metal component includes a flange and the flange is bent around an edge of the second component to form a joint between the first and second components.

3. The assembly of claim 2, wherein the joint includes the joint interface formed between a terminal end of the first component and the second component.

4. The assembly of claim 1, wherein the corrosion protection layer forms a seal between the first and second components along a portion of the joint interface.

5. The assembly of claim 1, wherein the corrosion protection layer has a mean thickness of 0.3 to 1.0 mm.

6. (canceled)

7. The assembly of claim 1, wherein the first and second components are sheet metal.

8. (canceled)

9. (canceled)

10. The assembly of claim 1, wherein the first component is an outer vehicle body panel and the second component is an inner vehicle body panel and the first component is crimped to the second component to form the joint interface.

11. A method of increasing corrosion resistance in an assembly, comprising:
thermally spraying a corrosion protection layer onto at least a portion of a joint interface between a first metal component and a second metal component, the corrosion protection layer including aluminum or zinc.

12. The method of claim 11, wherein the step of thermally spraying the corrosion protection layer includes heating a source material to a temperature at or above its melting point.

13. The method of claim 11, wherein the step of thermally spraying includes cold spraying in which a source material for the corrosion protection layer is not heated to a temperature at or above its melting point during the spraying process.

14. The method of claim 11, wherein thermally spraying the corrosion protection layer onto at least a portion of the joint interface includes forming a seal between the first and second metal components along a portion of the joint interface.

15. The method of claim 11, wherein the step of thermally spraying the corrosion protection layer includes spraying a layer comprising at least 99 wt. % aluminum.

16. The method of claim 11, wherein the thermally spraying step includes spraying a corrosion protection layer onto at least a portion of a joint interface between a first metal component and a second metal component wherein the first metal component includes a flange that is bent around an edge of the second metal component to form a joint including the joint interface between the first and second components.

17. The method of claim 11 further comprising, prior to the thermally spraying step, bending a flange of the first metal component around an edge of the second metal component to form a joint between the first and second components, the joint including the joint interface.

18. The method of claim 11, wherein the thermally spraying step includes spraying a corrosion protection layer having a mean thickness of 0.1 to 2.0 mm.

19. The method of claim 11, wherein the corrosion protection layer is sprayed onto the joint interface without prior cleaning or removal of material from the joint interface.

20. A method of increasing corrosion resistance of a sheet metal component, comprising:
thermally spraying a corrosion protection layer onto a cut-surface, sanded surface, or a joint interface of an aluminum sheet metal component, the corrosion protection layer comprising at least 90 wt. % aluminum and having a mean thickness of 0.1 to 2.0 mm.
